(19) United States
(12) Patent Application Publication
(10) Pub. No.: US 2005/0060870 A1
(43) Pub. Date: Mar. 24, 2005

(54) Shaft equipped with an optical coding ring and manufacturing process for this shaft

(76) Inventor: Angel Exposito, Bonneville (FR)

Correspondence Address: CLARK & BRODY, 1090 VERMONT AVENUE, NW, SUITE 250, WASHINGTON, DC, 20005, US

(21) Appl. No.: 10/924,948

(22) Filed: Aug. 25, 2004

(30) Foreign Application Priority Data
Aug. 28, 2003 (FR) 03 10 245

(51) Int. Cl. B23P 17/04

(52) U.S. Cl. 29/592

(57) ABSTRACT

Transmission shaft equipped with an attached optical coding ring. The whole capable of being assembled by broaching and crimping by rolling of the ring on the shaft.

The present invention relates to the technical domain of systems used to repeat the position of a mobile stimulated by a rotation movement.

The invention more particularly relates to systems ensuring marking the position of a transmission shaft to ensure that a mechanical system is set in rotation to create what is known as power drive.

The invention also relates to shafts for transmitting an order or a command to a mechanical system such as for example a transmission shaft used for transmitting information, sent from a steering wheel of a vehicle, in the direction of this same vehicle.

Within the scope of such an application for example it is necessary to be able to detect the position and the effort exerted on the transmission shaft to be able to assist the movement and thus the direction.

To this end, it is known to make use of a torsion gauge comprising two transmission shafts which are mobile in rotation relative to one another and attached in rotation by a torque rod. It is then necessary to recognise the position of each shaft making up the torsion gauge in both absolute and relative manner. In effect, the difference in angular position of the shafts is a function of the torsion couple applied to the transmission shaft.

So as to effect such angular marking of each transmission shaft, a technique has been developed consisting of connecting each transmission shaft to optical coding means which allow their position to be identified, with an adapted reading system. The optical coding means are in the form of a substantially cylindrical optical surface machined directly into the mass of the transmission shafts.

Such an embodiment has demonstrated the practicability of the process for optical detection of the position of the transmission shafts of the torsion gauge, but has the disadvantage of being particularly costly and thus not well adapted to mass production.

Therefore, the need has arisen for a new type of transmission shaft with optical coding and a manufacturing process satisfying the demands for high manufacturing precision especially of the optical surface utilised for detection of position, while offering less manufacturing cost, thus enabling torsion gauges to be made at an acceptable cost for the automobile industry especially.

In order to reach these objectives, the invention relates to a manufacturing process for a transmission shaft equipped with an optical coding ring comprising the following steps:
production of the transmission shaft, such that it comprises a reception range of the ring, having at least one fluted ring of axial direction,
production of the coding ring, such that it comprises, on one side, at least one peripheral external surface for the optical coding and, on the other side, an axial bore of a shape substantially similar to that of the range having a an internal diameter less than the largest diameter of the range, including the fluted ring, and comprising an internal collar which has a diameter less than the internal diameter of the axial bore,
broaching of the coding ring on the shaft at the level of the receiving range, so as to engage the grooves in the wall of the bore towards the internal collar, without engaging the grooves in the collar,
and crimping by rolling of the coding ring at a surface of the ring situated opposite the collar relative to the groove ring.

Association of the broaching and the rolling of the coding ring opposite the collar relative to the fluted ring advantageously imprison possible shavings of the material making up the coding ring likely to form during broaching. This imprisoning then guarantees perfect cleanness of the transmission shaft obtained by reducing to the maximum the risks of pollution or damage to the cylindrical external surface for optical coding of the ring.

According to the invention the fluted ring can be made in different ways.

According to a characteristic of the invention, the fluted ring is arranged in relief relative to the receiving range of the ring. The diameter of the fluted ring at the bottom of the grooves is preferably but not necessarily superior to the diameter of the range.

Different forms can be adopted for the fluted ring. According to a characteristic of the invention the fluted ring presents, in axial right section, a trapezoid or rectangular shape.

According to another characteristic of the invention, the grooves present, in transverse right section, a trapezoid or triangular shape, whether the fluted ring is made in relief or not.

According to the invention, the transmission shaft has at least one fluted ring and can thus comprise several thereof.

Therefore, according to a characteristic of the invention the transmission shaft is produced such that the receiving range of the ring has at least two fluted rings axially distant from one another.

Preferably but not strictly necessarily, rolling of the coding ring is then done at the level of the surface of the ring situated opposite the surface of the range which is located between the two fluted rings so as to crimp the material of the coding ring between the two fluted rings.

This advantageous arrangement of the invention helps to reinforce axial immobilisation of the optical coding ring on the transmission shaft.

According to the invention, the transmission shaft and its coding ring can be made of any suitable material. According to a preferred but not strictly necessary characteristic of the invention the transmission shaft is made of steel and the coding ring is made of a metal or a metal alloy having hardness less than that of the transmission shaft. In a preferred manner the coding ring is made of copper-nickel-zinc alloy, namely an alloy of copper, nickel and zinc, with or without another alloy element.

According to the invention, the external surface can be machined to create the optical coding means before or after broaching and rolling of said ring. All the same, the optical surface of the coding ring is preferably machined and made after broaching and crimping of said ring on the transmission shaft. This manufacturing method is particularly favoured by the technical advantages of the manufacturing process according to the present invention while broaching and crimping of the ring are done without removing shavings or polluting particles.

In a preferred but non-limiting application the process according to the invention is implemented to make a torsion gauge comprising two transmission shafts each equipped with an optical coding ring, mobile relative to one another in axial rotation, by being attached in rotation by a torque rod. This fabrication is then carried out in two steps:
fabrication of each of the transmission shafts according to the manufacturing process according to the invention described previously,
and assembly of the transmission shaft ensemble with the torque rod.

In a preferred manner broaching and crimping by rolling the optical rings on their respective shaft are performed prior to assembly of the shafts between one another, by means of the torque rod.

The two reflection zones (mirror) of the two optical rings are machined after assembly of the two shafts, so as to ensure perfect coaxiality of the two reflection surfaces.

The invention also relates to a transmission shaft characterised in that it comprises at least one attached optical coding ring.

The invention also concerns a torsion gauge comprising two transmission shafts, each mobile in rotation relative to one another, being connected in rotation by a torque rod, characterised in that each transmission shaft is equipped with an attached optical coding ring.

According to a preferred, but not strictly necessary, characteristic of the invention, the two optical coding rings of each of the transmission shafts making up the torsion gauge are placed adjacently.

According to a characteristic of the invention, the optical coding ring is broached and crimped by rolling on its transmission shaft, at the level of a receiving range of the ring. Of course, another assembly mode and assembly of the ring on the shaft could be feasible.

Various other characteristics of the invention will emerge from the description hereinbelow made in relation to the attached diagrams which illustrate a non-limiting embodiment example of a torsion gauge comprising two transmission shafts according to the invention.

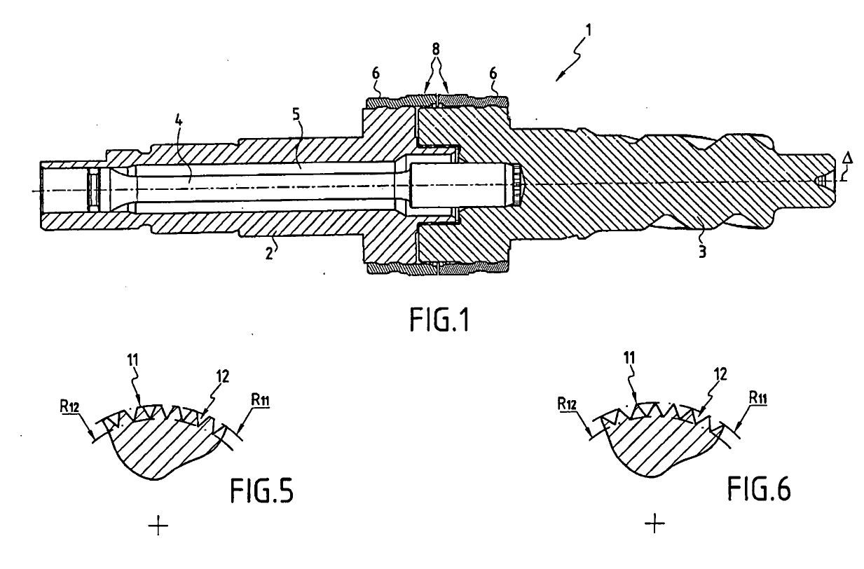

FIG. 1 is an axial section of a section gauge according to the invention.

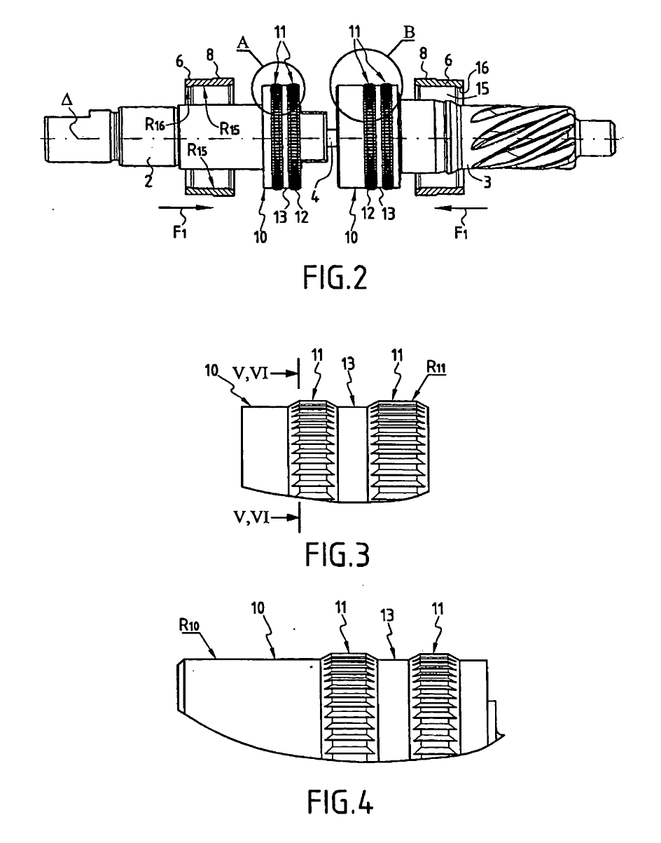

FIG. 2 is an exploded elevation in partial section of the torsion gauge according to FIG. 1.

FIG. 3 is a partial elevation on an enlarged scale of detail A of FIG. 2.

FIG. 4 is also an elevation on an enlarged scale of the detail B of FIG. 2.

FIG. 5 is a partial transverse section according to line V-V of FIG. 3.

FIG. 6 is a section similar to FIG. 5, showing another embodiment of the grooves.

The invention proposes a novel manufacturing process for a transmission shaft equipped with an optical coding ring such as capable of being used, for example but not necessarily, within the scope of a torsion gauge as illustrated more particularly in FIG. 1 and designated in its entirety by reference numeral 1.

Therefore, the torsion gauge 1 comprises two transmission shafts 2 and 3 of axis Δ. The transmission shafts 2 and 3 are mobile relative to one another in rotation of axis Δ and are connected by a torque rod 4, such that the two transmission shafts 2 and 3 are connected to one another in translation of axis Δ and are capable of knowing a relative rotation movement about the axis Δ according to the intensity of the couple applied to each of the two axes of transmission 2, 3. As shown in FIG. 1, the torque rod 4 is placed for this purpose in an axial bore 5 of the transmission shaft 2, so as to be connected by each of its two ends to one of the transmission shafts 2 and 3. This is an embodiment of a torsion gauge well known to the expert and therefore not requiring any further explanation.

In accordance with an essential characteristic of the invention and so as to allow optical detection of the angular position of the gauge 1 as well as of the relative angular position of the two transmission shafts 2 and 3, the latter are each equipped with an optical coding ring 6. According to the illustrated example the optical coding rings 6 are placed adjacently. Each optical coding ring 6 presents a peripheral external surface 8 for optical coding. The particular geometry of each peripheral external surface 8 does not enter the scope of the present invention. At the very most it is advisable to specify that each peripheral external surface 8 has a general cylindrical shape and is made so as to present one or more series of optical marks capable of being detected by means, not illustrated, at the same time allowing the angular position of the torsion gauge 1 to be recognised in its entirety, as well as the possible angular spacing between the two transmission shafts 2 and 3. To offer a satisfactory resolution the peripheral surfaces for the optical coding 8 must be made with a very high degree of precision and must have a very strong reflection index.

Considering the hardness of the materials making up the transmission shafts 2, making the optical coding surfaces directly in the material making up the latter would present prohibitive manufacturing costs for mass production. Accordingly, the invention proposes to attach the optical coding rings 6 on the transmission shafts 2 and 3.

The coding rings 6 can then be made of a material more malleable than the transmission shafts 2 and thus present lower machining costs.

The invention thus proposes to fabricate each transmission shaft 2, 3, such that it comprises a receiving range 10 of the coding ring 6. In accordance with an essential characteristic of the invention, each receiving range 10 then comprises at least one and, according to the example illustrated, two fluted rings 11 12 of axial direction Δ.

As shown more particularly in FIGS. 3 and 4 and according to the illustrated example, the two fluted rings 11 are arranged in relief relative to the range 10 and are distant axially from one another, such that the range 10 exhibits a smooth surface 13 between the rings 11. Each surface 13 defines, as will emerge hereinbelow, an axial immobilisation throat of the corresponding coding ring.

According to the example illustrated, the fluted rings present an axial cross-section substantially trapezoid, as shown more particularly in FIGS. 3 and 4. Likewise, according to the illustrated embodiment, the grooves exhibit a transverse cross-section of trapezoid shape, as shown in FIG. 5. However, when very good penetration of the grooves in the coding ring is wanted, a transverse cross-section of triangular shape will be adopted for the grooves, as illustrated in FIG. 6.

In addition, according to the illustrated example, the base of the grooves is positioned on a cylinder having a diameter R₁₂ greater than the minimum diameter R₁₀ of the collar 10 at the surface 13, especially.

Independently of the manufacture of each transmission shaft 2, 3, each of the optical coding rings 8 is made in a material having a hardness less than that of the steel making up the transmission shafts 2, 3 and, preferably, a malleable material, such as for example but not exclusively, in copper-nickel-zinc alloy. The rings 8 are each made so as to present a general cylindrical shape to comprise, on one hand, the peripheral external surface 8 and, on the other hand, an axial bore 15 of a shape substantially similar to that of the range and having an internal diameter R₁₅ less than the larger diameter R₁₁ of the range including the fluted ring 11.

The axial bore 15 is made so as to comprise an internal collar 16 which has a diameter R₁₆ less than the internal diameter R₁₅ of the axial bore 15 and, preferably, less than or equal to the smallest diameter R₁₀ of the range 10 including the fluted ring 11. According to the example illustrated, the internal diameter of the bore of the collar 16 is equal to the clearance close to the smallest diameter R₁₀ of the range 10.

The assembly of each coding ring 6 on its respective shaft 2, 3 is then undertaken by broaching, that is, by engaging the ring 6 on the range 10 in the direction of the arrow fl, so as to engage the grooves of the rings 11 in the wall of the bore 15 towards the internal collar 16, without nevertheless engaging the grooves 12 in the collar. During this engagement possible shavings of the material making up the ring 6 will then be banked up in the inverse direction of that F₁ of introduction and thus in the direction of the collar 16 and thus remain trapped.

After this broaching, according to another characteristic of the invention, rolling of the coding ring 6 thus adapted on the transmission shaft 2, 3 is undertaken at the level of a surface of the ring 6 situated opposite the collar 16 relative to at least one of the fluted rings 11 and according to the illustrated example at the level of the surface situated opposite the smooth surface 13 between the two rings 11. The resulting rolling contributes to immobilising the optical ring in axial translation, thus ensuring the integrity of the ring over time. According to the invention, broaching of the ring 6 and its rolling can be carried out at any stage of manufacturing of the gauge 1. All the same and preferably, the rolling intervenes after assembly of the two transmission shafts by way of the torque rod 4.

Additionally, according to the present invention the manufacture or machining of the optical coding means on the surface 8 can intervene at any stage and preferably after assembly of the axes and broaching and crimping of the rings, so as to ensure perfect correspondence of the optical marks arranged in the surfaces 8 when no couple is applied to the transmission shafts 2, 3.

According to the example described hereinabove and illustrated in FIGS. 1 to 5 the receiving ranges of the coding rings are provided with two fluted rings made in relief. Nevertheless, according to the present invention each receiving range of one coding ring could have only one fluted ring which would not necessarily be made in relief. Therefore, it would be feasible to make the grooves 12 over the entire axial length of the range 10 and the rolling would intervene on the edge of the ring opposite the collar 16, so as to realise crimping of the ring on the range 10.

In addition, according to the invention, the coding rings 6 and the axes of transmission 2, 3 are used within the scope of a torsion gauge 1, nevertheless, the invention could be used for any type of transmission shafts such as for example a transmission shaft of a rotating machine such as an electric motor or even a generator, a turbine or the like requiring implementation of optical coding means enabling detection of the angular position of the shaft and/or the angular speed of the transmission shaft.

It is understood that various other modifications can be made to the invention without departing from its scope.

1. A manufacturing process for a transmission shaft (2, 3) equipped with an optical coding ring (6) comprising the following steps:
production of the transmission shaft (2), such that it comprises a reception range (10) of the ring (6), having at least one fluted (12) ring (11) of axial direction (12) of the ring,
production of the coding ring (6), such that it comprises, on one side, at least one peripheral external surface (8) for the optical coding and, on the other side, an axial bore (15) of a shape substantially similar to that of the range (10) having a an internal diameter (R₁₅) less than the largest diameter (R₁₁) of the range (10), including the fluted ring (11), and comprising an internal collar (16) which has a diameter (R₁₆) less than the internal diameter (R₁₅) of the axial bore (15),
broaching of the coding ring (6) on the shaft (2, 3) at the level of the receiving range, so as to engage the grooves (12) in the wall of the bore (15) towards the internal collar (16), without engaging the grooves (12) in the collar (16),
and rolling of the adapted coding ring (6) on the transmission shaft (2,3) at the level of a surface of the ring (6) situated opposite the collar (16) relative to the fluted ring (11).

2. The manufacturing process as claimed in claim 1, characterised in that the collar (16) has an internal diameter (R₁₆) less than or equal to the smallest diameter (R₁₀) of the range (10), including the fluted ring (11).

3. The manufacturing process as claimed in claim 1, characterised in that the fluted ring (11) is arranged in relief relative to the receiving range (10) of the ring (6).

4. The manufacturing process as claimed in claim 3, characterised in that the diameter (R₁₆) of the fluted ring (11) at the level of the base of the grooves (12) is greater than the diameter (R₁₀) of the range (10).

5. The manufacturing process as claimed in claim 3, characterised in that the fluted ring (11) presents, in axial cross-section, a trapezoid or rectangular shape.

6. The manufacturing process as claimed in claim 1, characterised in that the grooves (12) present, in transverse cross-section, a trapezoid or triangular shape.

7. The manufacturing process as claimed in claim 1, characterised in that the transmission shaft (2, 3) is manufactured such that the receiving range of the ring (6) has at least two fluted rings (11) axially distant from one another.

8. The manufacturing process as claimed in claim 7, characterised in that rolling of the coding ring (6) is done at the surface of the ring (6) situated opposite the surface (13) of the range (10) which is situated between the two fluted rings (11), so as to crimp the material of the coding ring between the two fluted rings (11).

9. The manufacturing process as claimed in claim 1, characterised in that the transmission shaft (2,3) is made of steel and in that the coding ring (6) is made of a metal or metal alloy having hardness less than that of the transmission shaft (2, 3).

10. The manufacturing process as claimed in claim 9, characterised in that the coding ring (6) is made of copper-nickel-zinc alloy.

11. The manufacturing process for a torsion gauge comprising two transmission shafts (2, 3), each equipped with an optical coding ring (6), mobile relative to one another in axial rotation, being connected in rotation by a torque rod (4), characterised in that it comprises the following steps:
a. production of each of the transmission shafts (2, 3) according to the manufacturing process as claimed in claim 1,
b. and assembly of the transmission shafts (2, 3) ensemble with the torque rod (4).

12. The manufacturing process as claimed in claim 11, characterised in that rolling the optical coding rings (6) is done after assembly of the two shafts (2, 3).

13. A transmission shaft, characterised in that it comprises at least one attached optical coding ring (6).

14. The transmission shaft as claimed in claim 13, characterised in that the optical coding ring (6) is made of a material which is less hard than the transmission shaft.

15. The transmission shaft as claimed in claim 14, characterised in that the optical coding ring (6) is made of copper-nickel-zinc alloy.

16. A transmission shaft including at least one attached optical coding ring (6) and made by the process of claim 1.

17. A torsion gauge comprising two transmission shafts as claimed in claim 13, which are mobile in rotation relative to one another and connected in rotation by a torque rod (4) and each of which comprise a broached and rolled optical coding ring (6).

18. The torsion gauge as claimed in claim 17, characterised in that the optical coding rings (6) are adjacent.
